(19) United States
(12) Patent Application Publication
(10) Pub. No.: US 2002/0025392 A1
(43) Pub. Date: Feb. 28, 2002

(54) Permanent memorial created from cremation remains and process for making the same

(76) Inventors: Ted Arkell Yardley, Bradenton, FL (US); Paul Demkowicz, Gainesville, FL (US)

Correspondence Address: HOLLAND & KNIGHT LLP, PO BOX 1526, ORLANDO, FL, 32802-1526, US

(21) Appl. No.: 09/814,440

(22) Filed: Mar. 22, 2001

Related U.S. Application Data
(60) Provisional application No. 60/191,165, filed on Mar. 22, 2000.

(51) Int. Cl. A44C 23/00; C03B 25/00; B29C 37/02

(52) U.S. Cl. 428/3; 264/115; 264/138; 264/162; 264/235; 65/104

(57) ABSTRACT

A memorial product generated from the cremation remains of a deceased human or animal whereby a predetermined amount of bone ash is combined with a predetermined amount of a glass forming additive. In addition, a glass modifier may be added to enchance the durability of the final solid product. A flux may also be added to reduce the melting temperature of the mixture. These additives are combined with bone ash and milled to a desired particulate size to form a powder mixture. The mixture is heated to a melting temperature for a resident time to form a glass melt which is then poured into a mold. The cast or molded form is annealed for a resident time at a predetermined temperature to avoid stress fracture or crystalization from cooling too quickly or slowly.

This is a nonprovisional application claiming priority of the provisional application, Ser. No. 60/191,165 filed Mar. 22, 2000.

### FIELD OF THE INVENTION

This invention relates generally to memorializing the cremation remains of deceased humans or animals. More specifically, the invention pertains to the products or methods that fix the cremation remains in a permanent medium as a statue, ornament, gemstone or the like.

### BACKGROUND OF THE INVENTION

The cremation process involves incineration of a body in the presence of air in a specially designed furnace. Temperatures typically reach up to and above 1000° C. for several hours. During this time water is vaporized and all of the organic elements are oxidized and eliminated. What remains at the completion of the process are primarily broken fragments of bones and teeth, which are usually ground into a fine powder prior to disposal.

The main inorganic constituent of living bone is hydroxyapatite (Ca₅(PO₄)3OH). The calcium and phosphorous endure the high temperature firing and are oxidized in the presence of air. The cremated remains, therefore, are essentially calcium phosphate. The mixture is sometimes referred to as “bone ash.” The fundamental chemical constituents of bone ash (calcium and phosphorous oxides) are, in fact, common raw materials used in the processing of various glass and ceramic materials. This allows for the possibility of forming the cremated remains into a variety of enduring materials, which can become part of a lasting and meaningful memorial to the deceased, and represents a unique alternative to the standard and often uncomfortable practice of retaining the cremation remains indefinitely in an ornamental urn.

Cremation remains have been memorialized in a permanent fixture form. A personalized pet animal memorial product is disclosed in U.S. Pat. No. 5,016,330. A portion of the cremation remains is mixed with a moldable material such as a plaster composition, a wet ceramic mixture, or a porcelain product mixture. The moldable material is shaped to a designed figure, and the ash is permanently fixed in the shaped form when the moldable material hardens. Similarly, U.S. Pat. No. 6,200,507, discloses cremation remains fixed in a moldable resin material which fills a memorial urn.

However, these examples of a memorial do not utilize the ceramic and/or glass making properties of compounds comprising the bone ash as in the present invention.

### SUMMARY OF THE INVENTION

The present invention describes the conversion of cremated remains, through the application of heat and the addition of additives, into durable solid objects suitable for placement in a memorial display. The method or process of producing the memorial involves the formation of a vitreous (glassy) phase by firing the bone ash along with additional oxide materials to form a melt with the appropriate chemical composition which is cooled to form a ceramic and/or glassy solid. The material can be formed into the desired shape by casting from the melt and subsequent fabrication techniques such as cutting and polishing.

The processing of the cremation remains may begin with an initial grinding or milling step to produce a uniform powder. Additives, including a glass forming additive, are combined with the bone ash. Depending on the chemical composition required for the final material, the additive will have raw materials of the appropriate compounds which are mixed with the bone ash to produce a composite powder precursor or mixture. This is accomplished by simultaneously milling the powders together to achieve complete mixing and to reduce the particle size.

The additives are preferably provided in the form of raw materials in a frit phase, which frit additives are milled in a ball mill to an appropriate mill size, and combined with the bone ash. Utilizing frit additives reduces the temperature at which the mixture of additives and bone ash will melt and react to form glass melt.

The composite powder is then heated to a predetermined temperature for a resident time to form a melt. The melt is poured into a cast where it hardens. This hardened material is then annealed for a resident time and at a predetermined temperature. After the melt is annealed it is cooled to room temperature and the solid cast can be shaped if necessary by cutting and/or polishing techniques known by one skilled in the art. In addition, after product is shaped it may undergo a tonic transfer treatment that strengthens the cast surface.

### DETAILED DESCRIPTION OF THE INVENTION

The present invention utilizes the glass forming characteristics of phosphorous and calcium contained in cremation remains or bone ash to form a ceramic, glass, or artificial gemstone memorial. The bone ash is first milled to an appropriate particulate size of less than 850 microns. Additives are combined with the bone ash to create a precursor mixture. The additives may be in the form of a powdered frit raw material. If powder additives are used the additives are milled with the bone ash to an appropriate particulate size.

The raw materials are first treated to form a frit additive using standard procedures known by those skilled in the art. The frit additives are then milled to the appropriate mill size, preferably less than 850 microns. Frit additives are preferred in order to reduce the melting temperature of the combined mixture of bone ash and additives.

The additives contain oxide materials that are combined with the powdered cremation remains fall into several categories: glass formers, glass modifiers and a flux. Examples of each type of material include, but are not limited to:

1. Glass formers: SiO₂, B₂O₃ or any other compounds used for generation of ceramic or glass products;

2. Glass modifiers: Al₂O₃, TiO₂, ZnO₂;

3. Flux components: MgO, Na₂O, K₂O, Li₂O.

It should be understood that the term glass, glass former or glass modifier is not intended to limit the scope of the invention, but may include compounds that form ceramics. Glasses are often considered a subset of ceramics, or even as a purview of ceramics. So the invention is not limited to a glass or artificial gemstone, but may include a ceramic product. The invention is for a solid memorial product formed from a mixture of bone ash and additives.

The various additives are incorporated depending on the desired properties of the glass to be produced. In addition to these materials, small amounts of other metal oxides may be utilized in the glass batch to impart specific colors to the final material. These include, but are not limited to, Cr₂O₃, CuO, CoO, FeO, MnO₂, and NiO₃. The amount of colorant used ranges from a few tenths to several percent of the total batch weight

Further processing of the precursor powder is performed using standard glass forming techniques. The mixture is placed in a refractory crucible and heated in an electric furnace to temperatures of approximately 1300° C.-1500° C. The mixture of bone ash and additives forms a glass melt at these temperatures and maybe homogenized by stirring and/or bubbling of a gas through the melt. For example, mixing agents can be added to the mixture to create a bubbling action. The melt is poured into a shaped mold of graphite or stainless steel and annealed to avoid stress-induced cracking from rapid cooling or crystallization due to slow cooling. The solidified glass blank (a cast) is then formed into the desired shape or size by cutting and polishing.

Detailed analysis of the ash and preparation of several glass compositions using bone ash as a primary ingredient were performed. These glass compositions were melted, cast and annealed. As bone ash often contains many coarse particles and large bone fragments which are not conducive to a glass melting process, as a coarser particle size could result in less homogeneity in the melt and would lengthen overall processing times. The bone ash is preferably ball milled using cylindrical porcelain milling media to a particle size of less than 850 microns. This particle size is sufficient to obtain a homogeneous mixing of the milled ash and can be incorporated into a subsequent glass melt in a reasonable period of time.

The composition of bone ash from a horse was determined in order to conduct processing steps Thermogravimetric analysis (TGA) and differential thermal analysis (DTA) were used in order to identify changes in mass and any reactions occurring within a representative sample of the ash, as a function of temperature. It was observed through TGA that approximately a 5% mass loss occurred in the ash from 600° C. to 1425° C. (it should be noted that even at 1425° C. the bone ash did not melt). This mass loss was accompanied by a broad endotherm, as indicated by DTA. This is likely attributed to the loss of CO₂ as the ash is heated.

In addition, x-ray diffraction was performed on three random samples from the batch of milled bone ash in order to determine the homogeneity and phase composition of the material. There was little to no difference in diffraction patterns between the three random samples, indicating little variance in composition within the milled bone ash. Analysis of the major peaks of the x-ray diffraction data indicated the major components of the ash may include the following phases: calcium carbonate, calcium magnesium carbonate and calcium hydroxyapatite. The composition of bone ash is primarily calcium hydroxyapatite, with minor amounts of magnesium oxide and sodium oxide. In accordance with the x-ray diffraction results and the literature survey, the following was taken as the composition of the bone ash: 56.0 wt % CaO, 41.9 wt % P₂O_{5 ,} 1.1 wt % MgO and 1.0 wt % Na₂O. This composition was used as a basis for subsequent glass batch calculations.

It has been determined that the bone ash was primarily comprised of calcium and phosphate. From the TGA/DTA test analysis, it was apparent that even at 1425° C. the bone ash, by itself, would not melt or form a glassy material. Additives to the bone ash were necessary to lower its melting temperature and assist it in forming a glassy product. Phosphate glasses are not known to be very water durable. They tend to form polymeric chains due to the +5 valence of phosphorus. These chains may be easily “unraveled” when attacked by water. A common technique used to stabilize the structure of phosphate glasses is to add +3 valence cations so that a more durable, tetrahedral (+4 valence) structure is obtained. Components which may be added in order to accomplish this include A1₂O₃ and B₂O₃. Such compounds are referred to in this disclosure as glass modifiers which are those compounds that may modify the glass composition or charactistics. For example alumina, or aluminum oxide is added to stabilize the phosphorous formed glass.

The addition of Al₂O₃ increase the processing/melt temperature, requiring the addition of a flux to decrease the processing temperature. A common raw material suited for this is sodium carbonate (Na₂CO₃), which additive is sodium monoxide as above described.

As previously noted, the major component of the bone ash is calcium. Calcium, in high amounts, is not very conducive to glass forming. A glass former, such as SiO₂, would need to be added in order to reduce the overall calcium concentration.

The initial target composition included the following components: bone ash, plus a frit additive including Al₂O₃, Na₂O, and SiO₂. The raw material used to add the Al₂O₃ was aluminum hydroxide (Al(OH)₃), and the raw material used to add the Na₂O was Na₂CO₃.Five micron Min-U-Sil was used as the raw material for SiO₂. The following was the initial target composition for the first glass batch (Glass Batch #1):

| Component | Raw Material | wt % | Mol % | |
|---|---|---|---|---|
| CaO | Bone Ash | 16.81 | 22.42 | |
| P₂O₅ | Bone Ash | 12.56 | 6.62 | Bone Ash |
| MgO | Bone Ash | 0.34 | 0.63 | |
| Na₂O | Bone Ash | 0.29 | — | |
| Al₂O₃ | AI(OH)₃ | 13.81 | 6.62 | |
| Na₂O | Na₂CO₃ | 12.26 | 9.01 | Frit Additive |
| SiO₂ | SiO₂ | 43.93 | 54.70 | |

The initial attempt was to have the molar ratios of P₂O₅ and Al₂O₃ be identical, while satisfying approximately 70mol % glass former (P₂O₅, Al₂O₃, SiO₂) and 30mol % glass modifier (CaO, MgO, Na₂O). It happens that in this case, 7 parts (wt %) of frit added to 3 parts (wt %) of bone 10 ash would comprise the “glass” composition.

Tables 1 through 16 show an outline of the sixteen glass compositions evaluated, with heating schedule, annealing schedule and a physical description of the resulting product.

TABLE 1
Glass Batch #1

| Oxide | | RM* | Oxide** | Oxide | |
|---|---|---|---|---|---|
| Component | Raw Material | wt % | wt % | Mol % | |
| CaO | Bone Ash | 16.81 | 18.65 | 22.42 | |
| P₂O₅ | Bone Ash | 12.56 | 13.94 | 6.62 | Bone Ash |
| MgO | Bone Ash | 0.34 | 0.38 | 0.63 | (33.29 wt % |
| | | | | | bone ash) |
| Na₂O | Bone Ash | 0.29 | 0.32 | 0.35 | |
| Al₂O₃ | Al(OH)₃ | 13.81 | 10.01 | 6.62 | |
| Na₂O | Na₂CO₃ | 12.26 | 7.96 | 8.65 | Frit Additive |
| SiO₂ | SiO₂ | 43.93 | 48.74 | 54.70 | (66.71 wt % |
| | | | | | frit) |

*weight percent of raw materials added to the glass batch prior to melting
**weight percent of oxide components in the glass after melting

Frit Composition

| | Oxide mol % |
|---|---|
| Al₂O₃ | 9.46 |
| Na₂O | 12.37 |
| SiO2 | 78.17 |

The material was “charged” into a platinum crucible at 1315° C. in the Deltec high-temperature furnace and allowed to remain in the furnace at this temperature for approximately 20 hours.

Even after 20 hours at 1315° C., the material did not melt. It was a hard, foamy consistency inappropriate for glass pouring. The temperature of the furnace was increased to 1400° C. for two hours in order to promote melting. Melting did not occur.

For Glass Batch #2, additional flux (Na2O) and glass former (SiO₂) were added to assist in forming of a glass melt.

TABLE 2
Glass Batch #2

| Oxide | Raw | RM* | Oxide** | Oxide | |
|---|---|---|---|---|---|
| Component | Material | wt % | wt % | mol % | |
| CaO | Bone Ash | 13.84 | 15.44 | 16.48 | |
| P₂O₅ | Bone Ash | 10.34 | 11.53 | 4.86 | Bone Ash |
| MgO | Bone Ash | 0.28 | 0.31 | 0.47 | (27.55 wt % |
| | | | | | bone ash) |
| Na₂O | Na₂CO₃ | 0.24 | 0.27 | — | |
| Al₂O₃ | Al(OH)₃ | 11.37 | 8.29 | 7.45 | |
| Na₂O | Na₂CO₃ | 15.39 | 10.04 | 16.58 | Frit |
| | | | | | Additive |
| SiO₂ | SiO₂ | 48.53 | 54.13 | 53.92 | (72.45 wt % |
| | | | | | frit) |

*weight percent of raw materials added to the glass batch prior to melting
**weight percent of oxide components in the glass after melting

Frit Composition

| | Oxide mol % |
|---|---|
| Al₂O₃ | 9.46 |
| Na₂O | 12.37 |
| SiO₂ | 78.17 |

The material was “melted” in a platinum crucible at 1425° C. in the Deltec high-temperature furnace and allowed to remain in the furnace at this temperature for approximately 12 hours.

After 12 hours at 1425° C., the material did not melt. It was a 15 hard, foamy consistency inappropriate for glass pouring. The entire crucible plus contents was quenched in room temperature water. The contents of the crucible were extracted and examined. The contents appeared to have a white/greenish hue. The material was opaque and not a glass. It did appear to be uniform throughout.

Additional glass former (SiO₂) was then added in Glass Batch #3 to help promote glass forming.

TABLE 3
Glass Batch #3

| Oxide | Raw | RM* | Oxide** | Oxide | |
|---|---|---|---|---|---|
| Component | Material | wt % | wt % | mol % | |
| CaO | Bone Ash | 11.20 | 12.01 | 13.84 | |
| P₂O₅ | Bone Ash | 8.38 | 8.98 | 4.09 | Bone Ash |
| MgO | Bone Ash | 0.23 | 0.24 | 0.39 | (21.44 wt % |
| | | | | | bone ash) |
| Na₂O | Bone Ash | 0.20 | 0.21 | 0.22 | |
| Al₂O₃ | Al(OH)₃ | 9.21 | 6.45 | 4.09 | |
| Na₂O | Na₂CO₃ | 8.50 | 5.33 | 5.56 | Frit |
| | | | | | Additive |
| SiO₂ | SiO₂ | 62.28 | 66.77 | 71.83 | (78.56 wt % |
| | | | | | frit) |

*weight percent of raw materials added to the glass batch prior to melting
**weight percent of oxide components in the glass after melting

Frit Composition

| | Oxide mol % |
|---|---|
| Al₂O₃ | 5.02 |
| Na₂O | 6.82 |
| SiO₂ | 88.16 |

The material was “melted” in a platinum crucible at 1425° C. in the Deltec high-temperature furnace and allowed to remain in the 15 furnace at this temperature for approximately 6 hours.

After 6 hours at 1425° C., the material did not melt. It was a hard consistency inappropriate for glass pouring. The entire crucible plus contents was quenched in room temperature water. The contents of the crucible were extracted and examined. The contents appeared to have a white, opaque coloration. The material was not a glass. It did appear to be uniform throughout, however, with no additional coloration.

Additional flux (Na₂O) was ten added in Glass Batch #4 to help promote glass forming and reduce the processing temperature.

TABLE 4
Glass Batch #4

| Oxide | Raw | RM* | Oxide** | Oxide | |
|---|---|---|---|---|---|
| Component | Material | wt % | wt % | mol % | |
| CaO | Bone Ash | 9.56 | 10.96 | 12.59 | |
| P₂O₅ | Bone Ash | 7.15 | 8.19 | 3.72 | Bone Ash |
| MgO | Bone Ash | 0.19 | 0.22 | 0.35 | (19.56 wt % |
| | | | | | bone ash) |
| Na₂O | Bone Ash | 0.17 | 0.19 | 0.20 | |
| Al₂O₃ | Al(OH)₃ | 7.86 | 5.89 | 3.72 | |
| Na₂O | Na₂CO₃ | 24.19 | 16.22 | 16.86 | Frit |
| | | | | | Additive |
| SiO₂ | SiO₂ | 50.89 | 58.34 | 62.57 | (80.44 wt % |
| | | | | | frit) |

*weight percent of raw materials added to the glass batch prior to melting
**weight percent of oxide components in the glass after melting

Frit Composition

| | Oxide mol % |
|---|---|
| Al₂O₃ | 4.47 |
| Na₂O | 20.28 |
| SiO₂ | 75.25 |

The material was “melted” in a platinum crucible at 1425° C. in the Deltec high-temperature furnace and allowed to remain in the furnace at this temperature for approximately 12 hours.

After 12 hours at 1425° C., the material did melt. It was of a viscosity favoring glass pouring. The melt was poured into a graphite mold of the following dimensions (1.30 cm×1.30 cm ×12.0 cm). The cast rod was annealed at 540° C. for 2 hours in the Termolyne box furnace. The cast rod appeared to have white opacity throughout its interior. This could have been due to phase separation.

Glass Batch #5 had less Al₂O₃ content in order to lower the overall processing temperature.

TABLE 5
Glass Batch #5

| Oxide | Raw | RM* | Oxide** | Oxide | |
|---|---|---|---|---|---|
| Component | Material | wt % | wt % | mol % | |
| CaO | Bone Ash | 9.64 | 11.01 | 12.39 | |
| P₂O₅ | Bone Ash | 7.21 | 8.23 | 3.66 | Bone Ash |
| MgO | Bone Ash | 0.20 | 0.22 | 0.35 | (19.67 wt % |
| | | | | | bone ash) |
| Na₂O | Bone Ash | 0.17 | 0.20 | 0.20 | |
| Al2O3 | Al(OH)₃ | 1.00 | 0.74 | 0.46 | |
| Na₂O | Na₂CO₃ | 29.27 | 19.56 | 19.91 | Frit |
| | | | | | Additive |
| SiO₂ | SiO₂ | 52.53 | 60.03 | 63.04 | (80.33 wt % |
| | | | | | frit) |

*weight percent of raw materials added to the glass batch prior to melting
**weight percent of oxide components in the glass after melting

Frit Composition

| | Oxide mol % |
|---|---|
| Al₂O₃ | 0.55 |
| Na₂O | 23.87 |
| SiO₂ | 75.58 |

The material was “melted” in a platinum crucible at 1400° C. in the Deltec high-temperature furnace and allowed to remain in the furnace at this temperature for approximately 7 hours.

After 7 hours at 1400° C., the material did melt. It was of a viscosity favoring glass pouring. The melt was poured into a graphite mold of the following dimensions (1.30 cm×1.30 cm×12.0 cm). The cast rod was annealed at 500° C. for 2 hours in the Thermolyne box furnace. The cast rod was transparent/clear through its interior, with an amber hue. The amber hue could be imparted from impurities in the bone ash. In the center of the rod had a very slight “haze,” indicative of possible phase separation.

Glass Batch #6 had more frit additive in order to move completely out of this phase separation regime.

TABLE 6
Glass Batch #6

| Oxide | Raw | RM* | Oxide** | Oxide | |
|---|---|---|---|---|---|
| Component | Material | wt % | wt % | mol % | |
| CaO | Bone Ash | 9.20 | 10.54 | 11.84 | Bone Ash |
| P₂O₅ | Bone Ash | 6.87 | 7.87 | 3.49 | (18.81 wt % |
| MgO | Bone Ash | 0.18 | 0.21 | 0.33 | bone ash) |
| Na₂O | Bone Ash | 0.16 | 0.19 | 0.19 | |
| Al₂O₃ | Al(OH)₃ | 0.99 | 0.74 | 0.46 | Frit Additive |
| Na₂O | Na₂CO₃ | 29.80 | 19.97 | 20.29 | (81.19 wt % |
| SiO₂ | SiO2 | 52.79 | 60.48 | 63.40 | frit) |

*weight percent of raw materials added to the glass batch prior to melting
**weight percent of oxide components in the glass after melting

Frit Composition

| | Oxide mol % |
|---|---|
| Al₂O₃ | 0.55 |
| Na₂O | 24.11 |
| SiO₂ | 75.34 |

The material was “melted” in a platinum crucible at 1365° C. in the Deltec high-temperature furnace and allowed to remain in the furnace at this temperature for approximately 12 hours.

After 12 hours at 1365° C., the material did melt. It was of a viscosity favoring glass pouring. The melt was poured into a graphite mold of the following dimensions (1.30 cm×1.30 cm×12.0 cm). The cast rod was annealed at 500° C. for 2 hours in the Thermolyne box furnace. The cast rod was transparent/clear through its interior, with a slight amber/yellow hue. The amber hue could be imparted from impurities in the bone ash. Unlike the previous glass batch, there was no apparent phase separation.

Glass Batch #7 had a little addition of manganese dioxide in an attempt at “decolonization.”

TABLE 7
Glass Batch #7

| Oxide | Raw | RM* | Oxide** | Oxide | |
|---|---|---|---|---|---|
| Component | Material | wt % | wt % | mol % | |
| CaO | Bone Ash | 9.19 | 10.53 | 11.83 | Bone Ash |
| P₂O₅ | Bone Ash | 6.86 | 7.86 | 3.49 | (21.44 wt % |
| MgO | Bone Ash | 0.18 | 0.21 | 0.33 | bone ash) |
| Na₂O | Bone Ash | 0.16 | 0.19 | 0.19 | |
| Al₂O₃ | Al(OH)₃ | 0.99 | 0.74 | 0.46 | Frit Additive |
| Na₂O | Na₂CO₃ | 29.77 | 19.94 | 20.27 | (81.21 wt % |
| SiO₂ | SiO₂ | 52.74 | 60.41 | 63.35 | frit) |
| MnO₂ | MnO₂ | 0.10 | 0.11 | 0.08 | |

*weight percent of raw materials added to the glass batch prior to melting
**weight percent of oxide com ponents in the glass after melting

Frit Composition

| | Oxide mol % |
|---|---|
| Al₂O₃ | 0.55 |
| Na₂O | 24.09 |
| SiO₂ | 75.27 |
| MnO₂ | 0.10 |

The material was “melted” in a platinum crucible at 1365° C. in the Deltec high-temperature furnace and allowed to remain in the furnace at this temperature for approximately 7 hours.

After 7 hours at 1365° C., the material did melt. It was of a viscosity favoring glass pouring. The melt was poured into a graphite mold of the following dimensions (1.30 cm×1.30 cm×12.0 cm). The cast rod was annealed at 500° C. for 2 hours in the Thermolyne box furnace. The cast rod was transparent/clear through its interior, with a slight amber/yellow hue. The amber hue could be imparted from impurities in the bone ash. Unlike the previous glass batch, there was perhaps a little less coloration.

Glass Batch #8 had the same composition of Glass Batch #6, with the elimination of Al₂O₃ altogether, in order to lower the processing temperature even further.

TABLE 8
Glass Batch #8

| Oxide | Raw | RM* | Oxide** | Oxide | |
|---|---|---|---|---|---|
| Component | Material | wt % | wt % | mol % | |
| CaO | Bone Ash | 9.29 | 10.62 | 11.89 | Bone Ash |
| P₂O₅ | Bone Ash | 6.94 | 7.93 | 3.51 | (18.95 wt % |
| MgO | Bone Ash | 0.19 | 0.21 | 0.33 | bone ash) |
| Na₂O | Bone Ash | 0.16 | 0.19 | 0.19 | Frit Additive |
| Na₂O | Na₂CO₃ | 30.10 | 20.11 | 20.38 | (81.05 wt % |
| SiO₂ | SiO₂ | 53.32 | 60.93 | 63.69 | frit) |

*weight percent of raw materials added to the glass batch prior to melting
**weight percent of oxide components in the glass after melting

Frit Composition

| | Oxide mol % |
|---|---|
| Na₂O | 24.24 |
| SiO₂ | 75.76 |

The material was “melted” in a platinum crucible at 1360° C. in the Deltec high-temperature furnace and allowed to remain in the furnace at this temperature for approximately 15 hours.

After 15 hours at 1360° C., the material did melt. It was of a viscosity favoring glass pouring. The melt was poured into a graphite mold of the following dimensions (1.30 cm×1.30 cm×12.0 cm). The cast rod was annealed at 500° C. for 2 hours in the Thermolyne box furnace.

The cast rod was transparent/clear through its interior, with a amber/brownish hue. The amber hue could be imparted from impurities in the bone ash.

Glass Batch #9 had slightly more bone ash content.

TABLE 9
Glass Batch #9

| Oxide | Raw | RM* | Oxide** | Oxide | |
|---|---|---|---|---|---|
| Component | Material | wt % | wt % | mol % | |
| CaO | Bone Ash | 10.13 | 11.55 | 12.98 | Bone Ash |
| P₂O₅ | BoneAsh | 7.57 | 8.63 | 3.83 | (20.62 wt % |
| MgO | Bone Ash | 0.20 | 0.23 | 0.36 | bone ash) |
| Na₂O | Bone Ash | 0.18 | 0.21 | 0.21 | |
| Na₂O | Na₂CO₃ | 29.56 | 19.70 | 20.03 | Frit Additive |
| SiO₂ | SiO₂ | 52.36 | 59.68 | 62.59 | (79.38 wt % |
| | | | | | frit) |

*weight percent of raw materials added to the glass batch prior to melting
**weight percent of oxide components in the glass after melting

Frit Composition

| | Oxide mol % |
|---|---|
| Na₂O | 24.24 |
| SiO₂ | 75.76 |

The material was “melted” in a platinum crucible at 1360° C. in the Deltec high-temperature furnace and allowed to remain in the furnace at this temperature for approximately 20 hours.

After 20 hours at 1360° C., the material did melt. It was of a viscosity favoring glass pouring. The melt was poured into a graphite mold of the following dimensions (1.30 cm×1.30 cm×12.0 cm). The cast rod was annealed at 500° C. for 2 hours in the Thermolyne box furnace. The cast rod was transparent/clear through its interior, with a amber/brownish hue. The coloration appeared slightly darker than the rod cast from the previous batch. The amber hue could be imparted from impurities in the bone ash.

Glass Batch # 10 had even more bone ash content.

TABLE 10
Glass Batch #10

| Oxide | Raw | RM* | Oxide** | Oxide | |
|---|---|---|---|---|---|
| Component | Material | wt % | wt % | mol % | |
| CaO | Bone Ash | 12.01 | 13.61 | 15.40 | Bone Ash |
| P₂O₅ | Bone Ash | 8.98 | 10.18 | 4.55 | (24.29 wt % |
| MgO | Bone Ash | 0.24 | 0.27 | 0.43 | bone ash) |
| Na₂O | Bone Ash | 0.21 | 0.23 | 0.24 | |
| Na₂O | Na₂CO₃ | 28.35 | 18.79 | 19.24 | Frit Additive |
| SiO₂ | SiO₂ | 50.22 | 56.92 | 60.13 | (75.71 wt % |
| | | | | | frit) |

*weight percent of raw materials added to the glass batch prior to melting
**weight percent of oxide components in the glass after melting

Frit Composition

| | Oxide mol % |
|---|---|
| Na₂O | 24.24 |
| SiO₂ | 75.76 |

The material was “melted” in a platinum crucible at 1360° C. in the Deltec high-temperature furnace and allowed to remain in the furnace at this temperature for approximately 20 hours.

After 20 hours at 1360° C., the material did melt. It was of a viscosity favoring glass pouring. The melt was poured into a graphite mold of the following dimensions (1.30 cm×1.30 cm×12.0 cm). The cast rod was annealed at 500° C. for 2 hours in the Thermolyne box furnace. The cast rod had some opacity (“cloudiness”) within its interior, with a amber/brownish hue.

Glass Batch #11 had even more bone ash content.

TABLE 11
Glass Batch #11

| Oxide | Raw | RM* | Oxide** | Oxide | |
|---|---|---|---|---|---|
| Component | Material | wt % | wt % | mol % | |
| CaO | Bone Ash | 14.95 | 16.80 | 19.23 | Bone Ash |
| P₂O₅ | Bone Ash | 11.18 | 12.56 | 5.68 | (29.98 wt % |
| MgO | Bone Ash | 0.30 | 0.34 | 0.54 | bone ash) |
| Na₂O | Bone Ash | 0.26 | 0.29 | 0.30 | |
| Na₂O | Na₂CO₃ | 26.45 | 17.38 | 18.00 | Frit Additive |
| SiO₂ | SiO₂ | 46.86 | 52.64 | 56.25 | (70.02 wt % |
| | | | | | frit) |

*weight percent of raw materials added to the glass batch prior to melting
**weight percent of oxide components in the glass after melting

Frit Composition

| | Oxide mol % |
|---|---|
| Na₂O | 24.24 |
| SiO₂ | 75.76 |

The material was “melted” in a platinum crucible at 1360° C. in the Deltec high-temperature furnace and allowed to remain in the furnace at this temperature for approximately 20 hours.

After 20 hours at 1360° C., the material did melt. It was of a viscosity favoring glass pouring. The melt was poured into a graphite mold of the following dimensions (1.30 cm×1.30 cm×12.0 cm). The cast rod was annealed at 500° C. for 2 hours in the Thermolyne box furnace. The cast rod had much opacity within its interior, with a brownish hue, resulting in a “marble-like” appearance.

Glass Batch # 12 had even more bone ash content than previously.

TABLE 12
Glass Batch #12

| Oxide | Raw | RM* | Oxide** | Oxide | |
|---|---|---|---|---|---|
| Component | Material | wt % | wt % | mol % | |
| CaO | Bone Ash | 17.66 | 19.63 | 22.70 | Bone Ash |
| P₂O₅ | Bone Ash | 13.20 | 14.66 | 6.70 | (35.04 wt % |
| MgO | Bone Ash | 0.36 | 0.40 | 0.64 | bone ash) |
| Na₂O | Bone Ash | 0.31 | 0.34 | 0.36 | |
| Na₂O | Na₂CO₃ | 24.13 | 15.68 | 16.41 | Frit Additive |
| SiO₂ | SiO₂ | 44.34 | 49.28 | 53.19 | (64.96 wt % |
| | | | | | frit) |

*weight percent of raw materials added to the glass batch prior to melting
**weight percent of oxide components in the glass after melting

Frit Composition

| | Oxide mol % |
|---|---|
| Na₂O | 23.58 |
| SiO₂ | 76.42 |

The material was “melted” in a platinum crucible at 1400° C. in the Deltec high-temperature furnace and allowed to remain in the furnace at this temperature for approximately 20 hours.

After 20 hours at 1400° C., the material did melt. It was of a viscosity favoring glass pouring. The melt was poured into a graphite mold of the following dimensions (1.30 cm×1.30 cm×12.0 cm). The cast rod was annealed at 500° C. for 2 hours in the Thermolyne box furnace. The cast rod was completely opaque white. It was uncertain whether the material formed a glass at all. The boundaries of glass forming within the silicate-based compositions had been identified.

Glass Batch #13 will be of a borosilicate composition, in order to investigate its glass forming tendencies and processing characteristics.

TABLE 13
Glass Batch #13

| Oxide | Raw | RM* | Oxide** | Oxide | |
|---|---|---|---|---|---|
| Component | Material | wt % | wt % | mol % | |
| CaO | Bone Ash | 15.38 | 22.52 | 28.75 | Bone Ash |
| P₂O₅ | Bone Ash | 11.49 | 16.83 | 8.49 | (40.19 wt % |
| MgO | Bone Ash | 0.31 | 0.45 | 0.80 | bone ash) |
| Na₂O | Bone Ash | 0.27 | 0.39 | 0.45 | |
| B₂O₃ | Na₂CO₃ | 72.55 | 59.81 | 61.51 | Frit Additive |
| | | | | | (59.81 wt % |
| | | | | | frit) |

*weight percent of raw materials added to the glass batch prior to melting
**weight percent of oxide components in the glass after melting

Frit Composition

| | Oxide mol % |
|---|---|
| B₂O₃ | 100.00 |

The material was “melted” in a platinum crucible at 1170° C. in the Deltec high-temperature furnace and allowed to remain in the furnace at this temperature for approximately 20 hours.

After 20 hours at 1170° C., the material did melt. It was of an inhomogeneous viscosity (low viscosity on the surface, high viscosity near the bottom of the crucible). The melt was poured into a graphite mold of the following dimensions (1.30 cm×1.30 cm×12.0 cm). The cast rod was annealed at 500° C. for 2 hours in the Thermolyne box furnace. The cast rod was completely opaque, with a slight yellow coloration. It was uncertain whether the material formed a glass at all.

Glass Batch #14 included the addition of SiO₂ to promote homogeneity and glass forming.

TABLE 14
Glass Batch #14

| Oxide | Raw | RM* | Oxide** | Oxide | |
|---|---|---|---|---|---|
| Component | Material | wt % | wt % | mol % | |
| CaO | Bone Ash | 14.43 | 18.78 | 22.63 | Bone Ash |
| P₂O₅ | Bone Ash | 10.78 | 14.03 | 6.68 | (33.51 wt % |
| MgO | Bone Ash | 0.29 | 0.38 | 0.63 | bone ash) |
| Na₂O | Bone Ash | 0.25 | 0.33 | 0.36 | |
| Na₂O | Na₂CO₂ | 10.95 | 8.34 | 9.09 | Frit Additive |
| SiO₂ | SiO₂ | 20.70 | 26.94 | 30.30 | (66.49 wt % |
| B₂O₃ | Na₂CO₃ | 42.60 | 31.21 | 30.30 | frit) |

*weight percent of raw materials added to the glass batch prior to melting
**weight percent of oxide components in the glass after melting

Frit Composition

| | Oxide mol % |
|---|---|
| Na₂O | 13.04 |
| SiO₂ | 43.48 |
| B₂O₃ | 43.48 |

The material was “melted” in a platinum crucible at 1330° C. in the Deltec high-temperature furnace and allowed to remain in the furnace at this temperature for approximately 20 hours.

After 20 hours at 1330° C., the material did melt. It was of a viscosity appropriate for glass pouring. The melt was poured into a graphite mold of the following dimensions (1.30 cm×1.30 cm×12.0 cm).

The cast rod was annealed at 500° C. for 2 hours in the Thermolyne box furnace. The cast rod was completely opaque, uniformly white throughout. The opacity could be due to phase separation, as the surface of the cast rod appeared “glossy.”

Glass Batch #15 was the same as Glass Batch #8.

Glass Batch #15

| Oxide | Raw | RM* | Oxide** | Oxide | |
|---|---|---|---|---|---|
| Component | Material | wt % | wt % | mol % | |
| CaO | Bone Ash | 9.29 | 10.62 | 11.89 | Bone Ash |
| P₂O₅ | Bone Ash | 6.94 | 7.93 | 3.51 | (18.95 wt % |
| MgO | Bone Ash | 0.19 | 0.21 | 0.33 | bone ash) |
| Na₂O | Bone Ash | 0.16 | 0.19 | 0.19 | |
| Na₂O | Na₂CO₂ | 30.10 | 20.11 | 20.38 | Frit Additive |
| SiO₂ | SiO₂ | 53.32 | 60.93 | 63.69 | (81.05 wt % |
| | | | | | frit) |

*weight percent of raw materials added to the glass batch prior to melting
**weight percent of oxide components in the glass after melting

Frit Composition

| | Oxide mol % |
|---|---|
| Na₂O | 24.24 |
| SiO₂ | 75.76 |

The material was “melted” in a platinum crucible at 1360° C. in the Deltec high-temperature furnace and allowed to remain in the furnace at this temperature for approximately 16 hours.

After 16 hours at 1360° C., the material did melt. It was of a viscosity favoring glass pouring. The melt was poured into a graphite mold of the following dimensions (1.30 cm×1.30 cm×12.0 cm). The cast rod was annealed at 500° C. for 2 hours in the Thermolyne box furnace. The cast rod was transparent/clear through its interior, with a amber/brownish hue. The amber hue could be imparted from impurities in the bone ash.

Glass Batch #16 was of the same composition of Glass Batch #8, except that cremated dog remains were used as the ash raw material rather than cremated horse remains as in Glass Batch #8. This allowed for some visual comparisons between these two glasses.

TABLE 16
Glass Batch #16

| Oxide | Raw | RM* | Oxide** | Oxide | |
|---|---|---|---|---|---|
| Component | Material | wt % | wt % | mol % | |
| CaO | Bone Ash | 9.29 | 10.62 | 11.89 | Bone Ash |
| P₂O₅ | Bone Ash | 6.94 | 7.93 | 3.51 | (18.95 wt % |
| MgO | Bone Ash | 0.19 | 0.21 | 0.33 | bone ash) |
| Na₂O | Bone Ash | 0.16 | 0.19 | 0.19 | |
| Na₂O | Na₂CO₂ | 30.10 | 20.11 | 20.38 | Frit Additive |
| SiO₂ | SiO₂ | 53.32 | 60.93 | 63.69 | (81.05 wt % frit) |

*weight percent of raw materials added to the glass batch prior to melting
**weight percent of oxide components in the glass after melting

Frit Composition

| | Oxide mol % |
|---|---|
| Na₂O | 24.24 |
| SiO₂ | 75.76 |

The material was “melted” in a platinum crucible at 1360° C. in the Deltec high-temperature furnace and allowed to remain in the furnace at this temperature for approximately 20 hours.

After 20 hours at 1360° C., the material did melt. It was of a viscosity favoring glass pouring. The melt was poured into a graphite mold of the following dimensions (1.30 cm×1.30 cm×12.0 cm). The cast rod was annealed at 500° C. for 2 hours in the Thermolyne box furnace. The cast rod was transparent/clear through its interior, with white opaque cords, or ribbons, running through the interior. These could be regions of phase separation or discolorations imparted by impurities in the ash.

It can be understood from the foregoing that different combinations of the additives and bone ash created casts or molded forms of varying characteristics and changed parameters of the operating procedure. The composition of the bone ash in terms of the molar percentage of its constituent compounds obviously remained fairly constant, but the change of the weight percentage of the bone ash to that of the percent by weight to the additives effected the final product. The less bone ash used resulted in more clear or transparent glass product, while increased amounts of bone ash used resulted in less clear or more opaque product. In addition, increased amounts of bone ash resulted in higher operating (melting) temperatures at longer resident times.

Similarly, one may surmise that change the molar percentages of the additives with respect to one another changed the product characteristics and operating parameters. The reduction of the glass modifier aluminum oxide resulted in more transparent product, but increased the melting temperature. Consequently, additional flux may have been required. In addition, the durability of the product may have been compromised.

Target glass compositions were prepared and glass products of unique coloration were melted and cast. The hardnesses of these glass products were statistically similar and were approximately 94% that of a standard flat window glass. Some optimization of composition may be performed in order to increase these hardness values. All of the glass products containing bone ash which were fabricated underwent a 12 hour water durability test at 90° C. It should be noted that this was an aggressive durability test. It was decided to make this comparison to a flat glass standard due to the lack of any industry standard in evaluating the extent of corrosion in glasses. The addition of other components to these glasses, namely an increase in Al₂O₃ and decrease in Na₂O, may result in an increase in durability. It must be understood that such an approach would very likely increase the processing temperature of these glasses.

Another approach in optimizing hardness and durability would be to decrease the ash content in these glasses even further. In addition treatments are known and used to strengthen glass objects. One such procedure involves an ionic exchange on the surface of the cast. The cast or molded form is placed in a salt solution which is heated to 300° C.-500° C. An ionic transfer takes place between larger ions replacing smaller ions on the cast surface which strengthens the cast surface. This is a process which is used in strengthening lenses for glasses and know by those skilled in the art.

While the preferred embodiments of the present invention have been shown and described herein in the context of using glass formers or glass modifiers, in combination with bone ash, it will be obvious that such embodiments are provided by way of example only and not of limitation. Numerous variations, changes and substitutions will occur to those skilled in the art without departing from the invention herein. Accordingly, it is intended that the invention be limited only by the spirit and scope of the appended claims.

What is claimed is:

1. A memorial product created from the cremation remains of a human or animal, comprising:
a) bone ash of a deceased human or animal;
b) a glass forming additive combined with the bone ash, forming a mixture thereof; and
c) said mixture being processed to form said memorial product.

2. A memorial product as defined in claim 1 wherein said glass forming additive comprises a silica, silicon dioxide or a silicate, or aluminum oxide or boron (III) oxide.

3. A memorial product as defined in claim 1 further including a glass modifying additive.

4. A memorial product as defined in claim 3 wherein said glass modifying additive comprises aluminum oxide or titanium dioxide or zinc peroxide.

5. A memorial as defined in claim 1 further comprises a flux additive.

6. A memorial product as defined in claim 5 wherein said flux additive comprises sodium monoxide, magnesium oxide, potassium monoxide or lithium oxide.

7. A memorial product as defined in claim 1 wherein said mixture of a glass forming additive and bone ash includes at least 50% by weight of the glass forming additive.

8. A memorial product as defined in claim 3 wherein said mixture of a glass forming additive, a glass modifying additive and bone ash includes at least 30% by weight of the glass forming additive and at least 30% by weight of the glass modifying additive.

9. A memorial product as defined in claim 8 wherein said glass forming additive is silicon dioxide and said glass modifying additive is aluminum oxide.

10. A memorial product as defined in claim 9 wherein said flux additive is sodium oxide and said mixture includes at least 50% by weight of silicon dioxide, at least 0.5% by weight of aluminum oxide and at least 15% by weight of sodium monoxide.

11. A memorial product as defined in claim 1 wherein a colorant additive is added to the mixture.

12. A memorial product as defined in claim 12 wherein said colorant comprises Cr₂O₃, CuO, CoO, FeO, MnO₂ or NiO₃.

13. A memorial product containing the cremation remains of a deceased human or animal, said product taking the form of an artificial gemstone, comprising a predetermined amount of bone ash from said cremation remains combined with a predetermined amount of a glass forming additive forming a mixture wherein said mixture is heated to a glass melt and is then cooled to a molded form.

14. A memorial product as defined in claim 13 wherein said glass forming additive comprises a silicon based oxide, silica dioxide or silicate or boron (111) oxide.

15. A memorial product as defined in claim 13 wherein said glass forming additive comprises boron(III) oxide or aluminum oxide.

16. A memorial product as defined in claim 13 further comprising a predetermined amount of glass modifying additive having been combined with the bone ash and glass forming additive.

17. A memorial product as defined in claim 16 wherein said glass modifying additive comprises aluminum oxide, titanium oxide or zinc peroxide.

18. A memorial product as defined in claim 13 wherein said bone ash and glass forming additive is combine with a flux additive to reduce a melting temperature of the mixture.

19. A memorial product as defined in claim 18 wherein said flux additive comprises sodium monoxide, magnesium oxide, potassium monoxide or lithium oxide.

20. A memorial product as defined claim 13 wherein said glass melt is poured into a mold and hardens to form said molded form and said molded form is annealed at a predetermined temperature for a resident time.

21. A memorial product as defined in claim 20 where in said molded product is polished or cut to a desired size and/or shape.

22. A memorial product containing the cremation remains of a human or animal, comprising:
a) bone ash of a deceased human or animal;
b) a glass forming additive combined with the bone ash, forming a mixture thereof;
c) said mixture of bone ash and glass forming additive heated to predetermined temperature for a resident time, for melting said mixture to a glass melt;
d) said melt being poured into a mold and hardened, into a glass form and said glass form being annealed.

23. A memorial product as defined in claim 22 wherein said bone ash includes a phosphorous glass forming constituent and a glass modifying additive is combined with the bone ash to stabilize the phosphorous glass.

24. A memorial product as defined in claim 22 wherein said glass forming additive comprises a silicon dioxide or boron (III) oxide and a glass modifying additive comprises aluminum oxide, titanium oxide or zinc peroxide and a flux additive comprises magnesium oxide, sodium monoxide, potassium monoxide or lithium oxide.

25. A memorial product as defined in claim 22 wherein a glass modifier additive is combined with the glass forming additive and bone ash to form said mixture.

26. A memorial product as defined in claim 22 wherein a flux additive is combined with the glass forming additive and the bone ash to form said mixture.

27. A memorial product as defined in claim 22 wherein said product is cut to a desired figure or shape.

28. A memorial product as defined in claim 22 wherein said glass form is treated in a bath solution to undergo an ionic exchange between the solution and surface thereof to strengthen the glass form.

29. A process for making a memorial product, containing the cremation remains of a deceased human or animal comprising the steps of:
a) providing a predetermined amount of bone ash from said cremation remains;
b) adding a glass forming additive to the bone ash forming a mixture thereof;
c) melting said mixture into a glass melt;
d) allowing the glass melt to harden to a glass form; and,
e) annealing said glass form to form said memorial product.

30. A process as defined in claim 29 further comprising the step of milling the bone ash to a preselected mill size.

31. A process as defined in claim 30 wherein said mill size is less than 850 microns.

32. A process as defined in claim 29 further including the step of pouring the glass melt into said mold.

33. A process as defined in claim 29 further including the step of cutting said molded form to a desired shape or size.

34. A process as defined in claim 29 further including the step of polishing said molded form to a desired luster.

35. A process as defined in claim 29 further including the step of bathing the glass form in a solution for ionic exchange between said solution and the surface of the glass form.
